(19) United States
(12) Patent Application Publication
(10) Pub. No.: US 2005/0274242 A1
(43) Pub. Date: Dec. 15, 2005

(54) Pumpkin carving kit

(76) Inventors: Colleen McMahon, Fredericksburg, VA (US); Dave McMahon, Fredericksburg, VA (US)

Correspondence Address: LITMAN LAW OFFICES, LTD, PO BOX 15035, CRYSTAL CITY STATION, ARLINGTON, VA, 22215, US

(21) Appl. No.: 10/863,461

(22) Filed: Jun. 9, 2004

(51) Int. Cl. B26D 1/04

(52) U.S. Cl. 83/13; 83/932; 83/652; 30/315

(57) ABSTRACT

The pumpkin carving kit for carving shapes into pumpkins includes a knob and templates, which are used to form face shapes on a pumpkin. The kit may include a striking mallet and a scraper. The knob has a threaded connector extending Therefrom. Each template has a sharp bottom rim defining a cutting edge and a top rim. The top rim has a retention strip extending across it, and a threaded hole situated within the retention strip for receiving the threaded connector of the knob. Stabilizers are attached to the bottom rim of the template. The template is placed on the surface of a pumpkin, and the stabilizers steady the template against the pumpkin surface. The front surface of the knob is then struck either with the mallet or with the user's hand, forcing the sharp bottom rim of the template to pierce a shaped hole into the surface of the pumpkin.

### BACKGROUND OF THE INVENTION

1. Field of the Invention

The present invention relates to cutting/carving tools, and particularly to a pumpkin carving kit.

2. Description of the Related Art

Carving devices have been used for years at Halloween to cut faces into pumpkins. As the popularity of Halloween has risen greatly in the last century, a great variety of devices have been created to carve into the tough pumpkin shell. One of the most popular carving devices is the serrated knife. While the knife is effective in cutting into the shell, it is not necessarily the best option for carving the pumpkin. The serrated knife usually has a dull edge so that it can be handled by children without causing harm. But the dull edge also makes it more difficult to cut into the shell. Additionally, knives are harder for small hands to grip and push through the pumpkin surface.

A more effective and easier method of carving pumpkins is the use of templates to create shaped holes in the pumpkin shell. Some devices allow users make the shapes by pushing templates through the surface with the palms of their hands. Other devices employ mallets to drive templates into the pumpkin. Still other devices have a handle that attaches onto multiple templates, allowing for a variety of templates to be used for cutting into the pumpkin using the same handle.

However, these devices do not necessarily provide the most effective method of carving shapes into pumpkins. They may not allow for multiple shapes to be easily cut into the shell. In addition, many devices trap pumpkin pieces within the inside of the template or other cutting device and are difficult to remove from within the template. Therefore, there is a need for a carving kit that makes multiple shapes in a pumpkin, is easy to manipulate, and allows a user to easily remove trapped pumpkin pieces from within the cutting device.

U.S. Pat. No. 4,689,885, issued Sep. 1, 1987 to T. Albanese, describes a pumpkin carving apparatus. Various housings are included that are each shaped differently, for example, as eyes, noses and mouths. Each housing has a boss with internal threads into which a handle is removably threaded. The housing with the handle is then pushed into the pumpkin surface, cutting a shape in the pumpkin.

U.S. Pat. No. 6,578,710, issued Jun. 17, 2003 to B. Brown et al., describes a pumpkin carving kit including pumpkin carving dies, a tool for driving the die into the pumpkin, a scoop and a scraping tool. The carving dies are shaped differently. The die is placed against the pumpkin shell and struck with the driving tool. The scoop and scraping tool scrape out the insides of the pumpkin so that the carving die may extend within the pumpkin shell.

U.S. Pat. No. 5,778,541, issued Jul. 14, 1998 to R. McClung, describes an electric-powered pumpkin carver. Blades of varying sizes and shapes may be inserted within the electric handle of the carver. The carver is used to carve into the surface of a pumpkin. Additionally, the carver has a safety lock.

Other patents describing pumpkin carving devices include U.S. Des. Pat. No. 337,703, issued Jul. 27, 1993 to D. Fox, Sr. (pumpkin cutter set); U.S. Pat. Pub. No. 2003/0056373, published Mar. 27, 2003 (interchangeable head carving tool); U.S. Pat. Pub. No. 2004/0035744, published Feb. 26, 2004 (pumpkin decorating kit); U.S. Pat. No. 376,136, issued Jan. 10, 1888 to A. Burrowes (punch); U.S. Pat. No. 2,720,176, issued Oct. 11, 1955 to R. Babbitt (mold with interchangeable product dislodging devices); U.S. Pat. No. 2,990,615, issued Jul. 4, 1961 to W. Ohler (fruit and vegetable coring tool); U.S. Pat. No. 4,296,659, issued Oct. 27, 1981 to C. Nauman (jack-o-lantern forming method); U.S. Pat. No. 4,828,114, issued May 9, 1989 to J. Bardeen (pumpkin carving kit); U.S. Pat. No. 5,687,484, issued Nov. 18, 1997 to M. Hahn (pumpkin carving knife); U.S. Pat. No. 5,933,968, issued Aug. 10, 1999 to A. Solomon (pumpkin cutter); U.S. Pat. No. 6,058,610, issued May 9, 2000 to I. Leang (decorative food cutter); U.S. Pat. No. 6,209,434, issued Apr. 3, 2001 to O. Kim et al. (paper sheet decorative punching device); U.S. Pat. No. 6,342,175, issued Jan. 29, 2002 to B. Brown et al. (method of carving shapes in a pumpkin shell); U.K. Pat. No. 840,057, published Jul. 6, 1960 (an improved press knife); and International Pat. No. WO 01/43990, published Jun. 21, 2001 (pumpkin decorating kit and method using light guiding pegs).

None of the above inventions and patents, taken either singly or in combination, is seen to describe the instant invention as claimed. Thus, a pumpkin carving kit solving the aforementioned problems is desired.

### SUMMARY OF THE INVENTION

The pumpkin carving kit is a kit for carving shapes into pumpkins. The kit includes a knob and a plurality of hollow templates defining cutting blades in shapes that are used to form the face of a pumpkin. The kit may additionally include a striking mallet and a scraper. The knob has a threaded connector extending therefrom. Each template has a sharp bottom rim defining a cutting edge and a top rim. The top rim has a retention strip extending across it, and a threaded hole situated within the retention strip. The threaded hole receives the threaded connector so that the knob and template are joined together. Stabilizers are attached to the bottom rim of the template.

The template is placed on the surface of a pumpkin, and the stabilizers steady the template against the pumpkin surface. The knob is then struck either with the mallet or with the user's hand, forcing the sharp bottom rim of the template to pierce a shaped hole into the surface of the pumpkin. A pumpkin piece generally becomes lodged into the template. When the knob and template are pulled out of the pumpkin and the knob is unthreaded, the pumpkin piece may be removed by pressing the piece out of the template. The user pushes the pumpkin piece out by pressing down on the space between the top rim of the template and the retention strip. Additionally, if the pumpkin piece remains stuck within the template, the individual can use the scraper to scrape the piece out.

Advantageously, the pumpkin carving kit allows for a variety of shapes to be created on the pumpkin surface. Further, the knob provided with the kit allows the user to more easily and comfortably push a template into a pumpkin, carving a shaped hole in the surface.

These and other features of the present invention will become readily apparent upon further review of the following specification and drawings.

### BRIEF DESCRIPTION OF THE DRAWINGS

FIG. 1 is a perspective view of a pumpkin carving kit according to the present invention.

FIG. 2 is an environmental, perspective view of the pumpkin carving kit according to the present invention.

FIG. 3 is a perspective view of the pumpkin carving kit according to the present invention as seen from the top.

FIG. 4 is a perspective view of the pumpkin carving kit according to the present invention as seen from the bottom.

Similar reference characters denote corresponding features consistently throughout the attached drawings.

### DETAILED DESCRIPTION OF THE PREFERRED EMBODIMENT

The present invention is a pumpkin carving kit, designated generally as 10 in the drawings. The kit 10 includes a knob 12 and a plurality of templates 14, which define cutting edges having shapes that are used to form the face of a pumpkin 50. The kit 10 may additionally include a striking mallet 16 and a scraper 18. Each template 14 is adapted to receive the knob 12. The knob 12 is threaded onto the template 14, and the template 14 is positioned on the surface of a pumpkin 50. The knob 12 is then pushed into the pumpkin by hand or struck with the mallet 16, forcing the template 14 to pierce a shaped hole into the surface of the pumpkin 50.

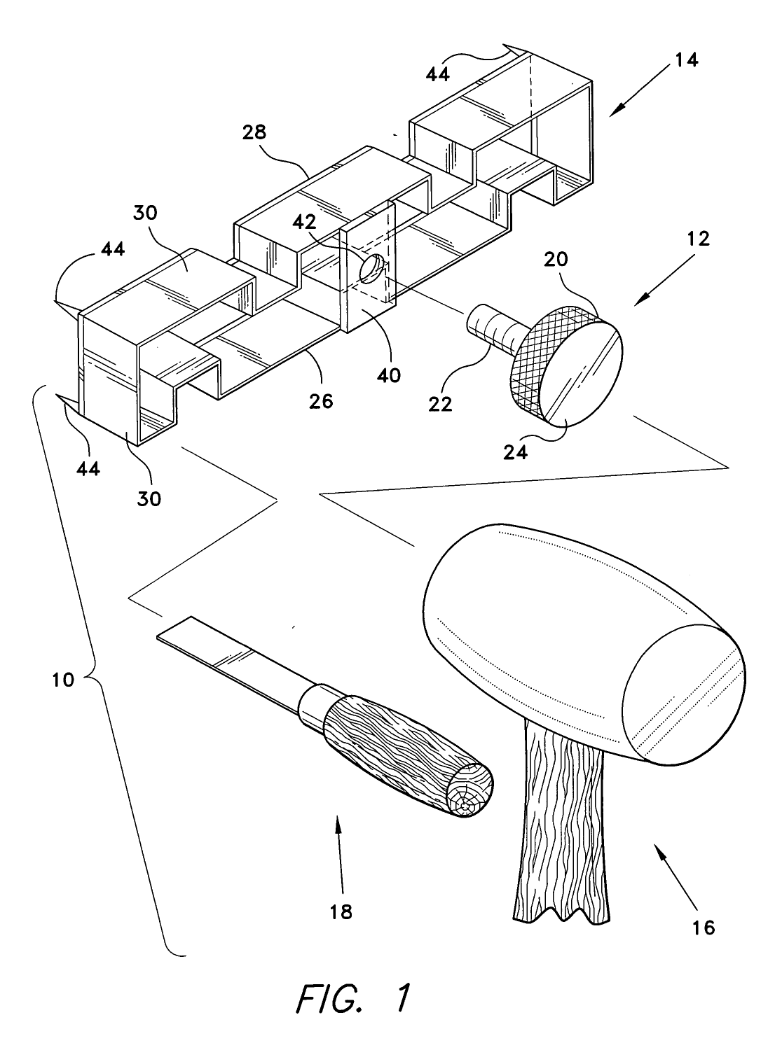

Referring first to FIG. 1, the knob 12 has a body portion 20 and a threaded connector 22. The body portion 20 of the knob 12 has a flat front surface 24, which is struck either by the mallet 16 or by a user's hand. The threaded connector 22 extends off of the knob body portion 20. The body portion 20 may have knurled edges to aid in threading and unthreading the knob 12 from the template 14. Each template 14 is a different face shape, for example, an eye, a nose or a mouth. Each template 14 is hollow and has a top rim 26, a bottom rim 28, and sidewall(s) 30 extending between the top rim 26 and the bottom rim 28. The bottom rim 28 is a sharp surface defining a cutting edge used to pierce a pumpkin shell. Each template 14 has a retention strip 40 extended across the middle of the top rim 26 of the template 14. The retention strip 40 is preferably a flat, rigid metal strap. A threaded hole 42 is situated within the retention strip 40. The threaded hole 42 is capable of receiving the threaded connector 22, allowing the knob 12 to be threaded onto the template 14. Stabilizers 44, e.g., sharp pins, extend off of the bottom rim 28 of the template 14.

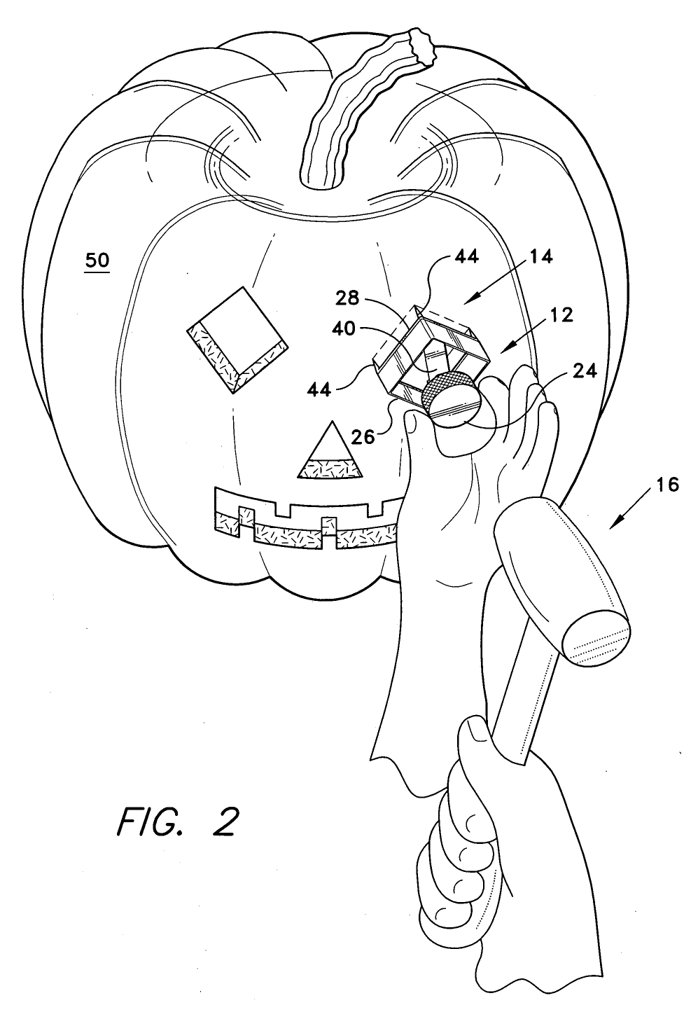

FIG. 2 shows the knob 12 and a template 14 joined together and set upon the surface of the pumpkin 50 (note that the shapes defined by the templates 14 in FIGS. 1 and 2 are different and exemplary only, the number of template 14 shapes encompassed within the scope of the present kit 10 not being limited). Once the knob 12 is threaded onto the template 14, the user places the template 14 on the surface of the pumpkin 50. The stabilizers 44 position the template 14 onto the shell of the pumpkin 50 by piercing the shell of the pumpkin and the user strikes the flat front surface 24 of the knob 12, pushing the sharp bottom rim 28 of the template 14 through the shell of the pumpkin 50. The user may strike the front surface 24 of the knob 12 with the mallet 16. Additionally, the user may strike the front surface 24 of the knob 12 with the user's hand. The template 14 extends through the surface of the pumpkin 50 and cuts the shape defined by the template 14 out of the shell. A pumpkin piece generally becomes lodged into the template 14. When the knob 12 and template 14 are pulled out of the pumpkin 50 and the knob 12 is unthreaded, the pumpkin piece may be removed by pressing the piece out of the template 14. The user pushes the pumpkin piece out by pressing down on the space between the top rim 26 of the template 14 and the retention strip 40. If the pumpkin piece remains stuck inside the template 14, the scraper 18 may be used to scrape the piece out from within the template 14.

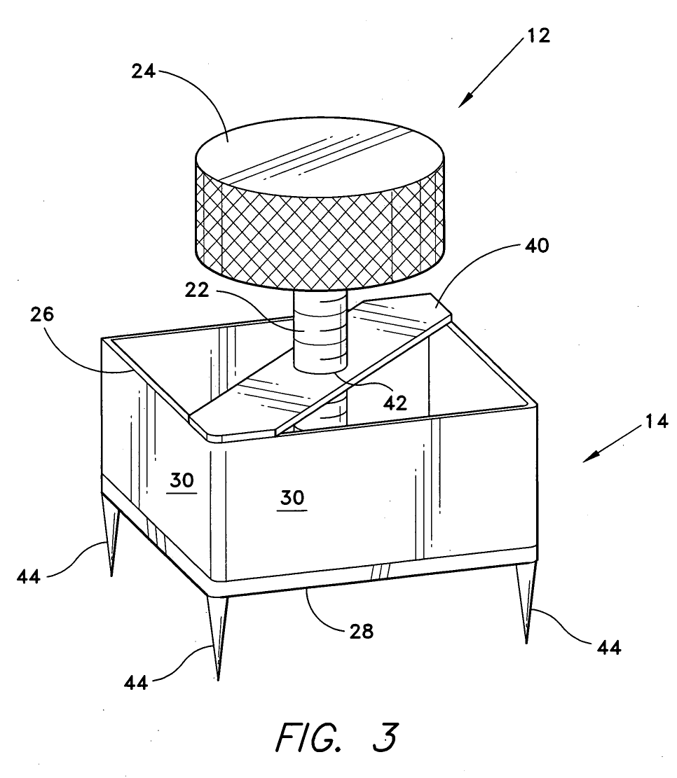

FIG. 3 shows a top perspective view of the knob 12 and the template 14. The stabilizers 44 extend off of the sharp bottom rim 28. The threaded connector 22 is threaded into the threaded hole 42 in the retention strip 40. The retention strip 40 is made of a strong material, such as steel, so that the strip 40 does not bend or warp when the knob 12 is struck on the front surface 24. The template 14 is hollow and contains a top rim 26, a sharp bottom rim 28 and sidewalls 30 connecting the top rim 26 and bottom rim 28.

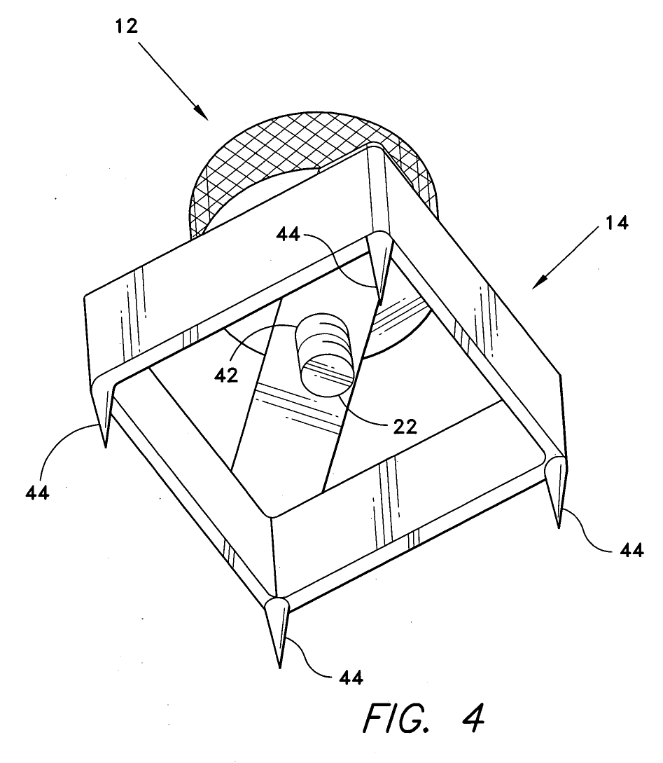

FIG. 4 shows a bottom perspective view of the threaded connector 22 inserted within the threaded hole 42. The knob 12 becomes locked together with the template 14.

The pumpkin carving kit 10 may be used on a variety of fruit or vegetables.

It is to be understood that the present invention is not limited to the embodiment described above, but encompasses any and all embodiments within the scope of the following claims.

1. A pumpkin carving kit, comprising:
a knob having a body with a flat front surface and a threaded connector extending from the body opposite the front surface; and
at least one template defining a shape adapted for carving a feature of a pumpkin face, the template having a top rim, a bottom rim, and a sidewall extending between the top rim and the bottom rim;
a retention strip extending across the top rim, the strip having a threaded hole defined therein, the threaded connector of the knob releasably engaging the threaded hole of the retention strip in order to temporarily attach the knob to the template.

2. The pumpkin carving kit according to claim 1, further comprising a mallet, the mallet having a head dimensioned for striking the front surface of said knob.

3. The pumpkin carving kit according to claim 1, further comprising a scraper.

4. The pumpkin carving kit according to claim 1, wherein said at least one template further comprises a plurality of stabilizers extending from the bottom rim, the stabilizers being adapted for piercing a pumpkin shell in order to keep the template steady when driving the template into the shell.

5. The pumpkin carving kit according to claim 1, wherein said at least one template is hollow.

6. The pumpkin carving kit according to claim 1, wherein the bottom rim of said at least one template is a sharp surface defining a cutting edge.

7. The pumpkin carving kit according to claim 1, wherein the retention strip is a flat metal strap.

8. The pumpkin carving kit according to claim 1, wherein the retention strip is made from steel.

9. The pumpkin carving kit according to claim 1, wherein said at least one template comprises a plurality of templates, each of said templates defining a different shape.

10. The pumpkin carving kit according to claim 1, wherein said knob has knurled edges.

11. The pumpkin carving kit according to claim 1, wherein said stabilizers comprise sharp pins.

12. A method for carving shapes into a pumpkin surface, comprising the steps of:
providing a template having at least one sidewall defining a pumpkin face feature, the sidewall having a top rim, a sharp bottom rim defining a cutting edge, a retention strip extending across the top rim, and a threaded hole defined within the retention strip;
threading a knob having a flat surface and a threaded connector into the threaded hole;
striking the flat surface of the knob; and
piercing the pumpkin surface with the bottom rim of the template.

13. The method for carving shapes into a pumpkin surface according to claim 12, further comprising the step of striking the flat surface of the knob with a mallet.

13. The method for carving shapes into a pumpkin surface according to claim 12, further comprising the step of scraping a pumpkin piece from within the template with a scraper.

14. The method for carving shapes into a pumpkin surface according to claim 12, wherein the template has a plurality of stabilizers extending from the bottom rim, the method further comprising the step of driving the stabilizers into the pumpkin surface in order to steady the template while performing the piercing step.
